(19) United States
(12) Patent Application Publication
(10) Pub. No.: US 2008/0168034 A1
(43) Pub. Date: Jul. 10, 2008

(54) MULTI FUNCTION PERIPHERAL APPARATUS, USER TERMINAL, SYSTEM, SEARCHING METHOD FOR THE MULTI FUNCTION PERIPHERAL APPARATUS AND COMPUTER PROGRAM

(75) Inventor: Hiroteru Tsuchiya, Numazu-shi (JP)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 11/620,807

(22) Filed: Jan. 8, 2007

(51) Int. Cl. G06F 17/30

(52) U.S. Cl. 707/3

(57) ABSTRACT

In a multi function peripheral apparatus of the present invention, a search request receiving unit receives from a network a user identifier and a search request containing type of one of plural functions, and a user management information holding unit holds user management information data in which information related to limitation of use by each user is written for each type of the plural functions. A user management information search unit searches for the information related to limitation of use of the user management information data corresponding to the user identifier contained in the search request received by the search request receiving unit, from the user management information holding unit. A user management information sending unit sends to the network the information related to limitation of use found by search by the user management information search unit. Thus, a multi function peripheral apparatus available to the user can be easily searched for, for each function, from the plural multi function peripheral apparatuses.

### BACKGROUND OF THE INVENTION

1. Field of the Invention

The present invention relates to a multi function peripheral apparatus, a user terminal, a system having the multi function peripheral apparatus and the user terminal, a searching method for the multi function peripheral apparatus in the system, and a computer program used for the user terminal.

2. Description of the Related Art

As a technique using a multi function peripheral apparatus, it has been proposed to enable count-up processing allocated to different departments in the case where processing to plural output destinations and repetition of the same processing for plural times are carried out in a department management control system for a digital multi function peripheral apparatus, and to limit, for each department, the count-up processing allocated from other departments (for example, JP-A-2004-282273).

A multi function peripheral apparatus is connected to a computer (PC) and a server device via a network. Recently, as a multi function peripheral apparatus connected to a network, a multi function peripheral apparatus that permits or limits available functions in accordance with the user has been commercially available. In a system where plural computers use a multi function peripheral apparatus, the functions available to each computer, of plural functions such as copy, scan, color print or monochrome print, are registered to a server device that manages the multi function peripheral apparatus, for each computer.

The computers cannot change or set the registered limited availability for each function, for example, each predetermined number of print sheets in the case of print. Therefore, when a computer attempts to use a different function from the registered available functions, the computer searches for the machine of the multi function peripheral apparatus connected to the network, by the name or identifier of the multi function peripheral apparatus. However, in the case where the multi function peripheral apparatus having plural functions can be searched for, the multi function peripheral apparatus that is found by search does not necessarily permit the user to use the intended function.

### DESCRIPTION OF THE DRAWINGS

FIG. 1 is a configuration view of a server client system according to an embodiment of the invention.

FIG. 2 is a view for explaining processing of user management carried out by function in a multi function peripheral apparatus according an embodiment of the invention.

FIG. 3 is a view for explaining processing of user management carried out by function in another multi function peripheral apparatus according an embodiment of the invention.

FIG. 4 is a view for explaining processing of user management carried out by color and by the number of print sheets in a multi function peripheral apparatus according an embodiment of the invention.

FIG. 5 is a schematic block diagram of a user terminal according to an embodiment of the invention.

FIG. 6 is a flowchart for explaining search processing for a multi function peripheral apparatus by function at a user terminal according to an embodiment of the invention.

FIG. 7 is a view showing an exemplary search screen display for a multi function peripheral apparatus at a user terminal according to an embodiment of the invention.

FIG. 8 is a view showing another exemplary search screen display for a multi function peripheral apparatus at a user terminal according to an embodiment of the invention.

FIG. 9 is a view showing an exemplary display for a multi function peripheral apparatus generated by a multi function peripheral display data generating unit of a user terminal according to an embodiment of the invention.

FIG. 10 is a flowchart for explaining extraction processing for information related to limitation of use of user management information data in a multi function peripheral apparatus according to an embodiment of the invention.

FIG. 11 is a flowchart for explaining search processing for a multi function peripheral apparatus having a network print function, at a user terminal according to an embodiment of the invention.

FIG. 12 is a flowchart for explaining search processing for a multi function peripheral apparatus capable of network print by color, at a user terminal according to an embodiment of the invention.

FIG. 13 is a view for explaining search processing for a multi function peripheral apparatus that has not reached an upper limit number of print sheets for network print, at a user terminal according to an embodiment of the invention.

### DETAILED DESCRIPTION OF THE INVENTION

Throughout this description, the embodiments and examples shown should be considered as exemplars, rather than limitations on the apparatus and methods of the present invention.

Hereinafter, an embodiment of the present invention will be described in detail with reference to the accompanying drawings as examples.

In the drawings, the same parts are denoted by the same reference numerals and duplicate description will not be given.

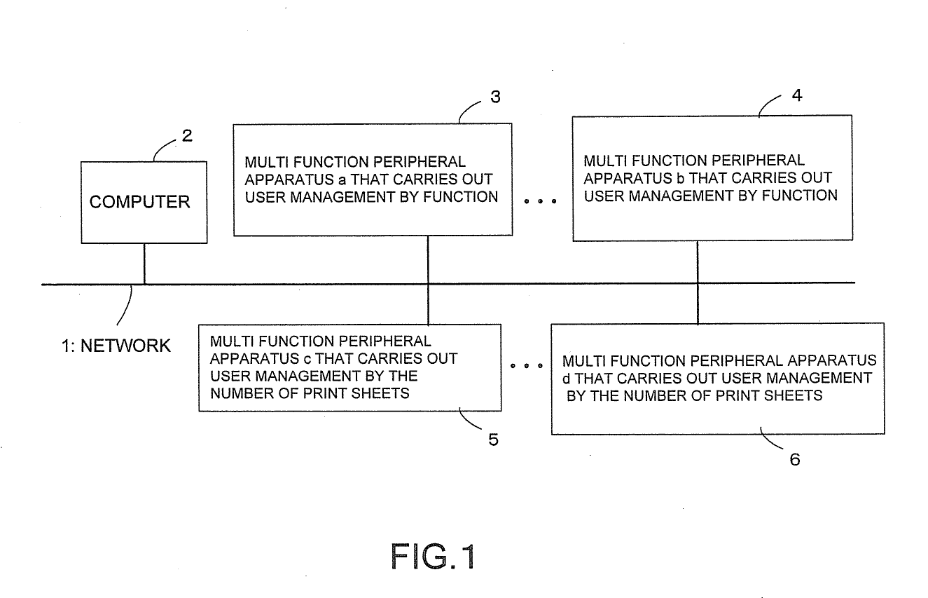

A server client system according to this embodiment has a network 1, multi function peripheral apparatuses 3 to 6 connected to the network 1, and plural computers 2 connected to the network 1, as shown in FIG. 1. In FIG. 1, one computer 2 is shown.

The multi function peripheral apparatuses 3 to 6 are MFPs (multi function peripherals) having multiple functions such as network print, copy, facsimile communication, and scan. Each of the multi function peripheral apparatuses 3 to 6 is provided with a network interface module that exchanges data with the network 1, an image generating module that optically reads an original and generates data for copy, a FAX device that sends and receives data to and from a public line, a scanner that scans an original and generates image data, and a print module that carries out one or both of color print and monochrome print. The multi function peripheral apparatuses 3 to 6 have a memory device for storing data or files, a CPU, a ROM, a RAM, an IC, an LSI and the like.

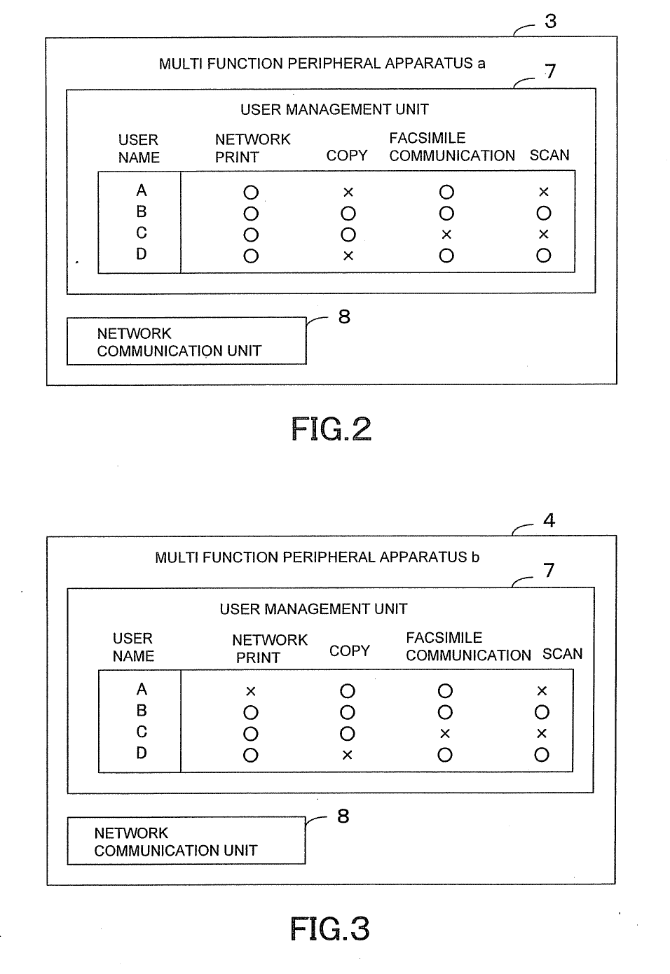

The multi function peripheral apparatus 3 is to carry out user management by function, and has a user management unit 7 and a network communication unit 8 as shown in FIG. 2.

The user management unit 7 is to hold user management information data in which information related to limitation of the use by each user for each type of plural functions, and to search for information related to limitation of the use of user management information data corresponding to a user identifier (for example, user name) contained in a search request received by the network communication unit 8, which will be described below. The user management unit 7 functions as a user management information holding unit and as a user management information search unit.

Specifically, the user management information is the information about whether plural users can or cannot use each of the plural functions. This information is used for managing the users by function. The user management information for limitations such as permission or prohibition of the functions available to each user is managed by the user management unit 7. The user management unit 7 is realized by a memory device and CPU. As a memory device that holds the user management information data, a separate memory device from the user management unit 7 may be used. Alternatively, it may be configured to be removable from the multi function peripheral apparatus 3.

The network communication unit 8 is to receive a search request containing the user name and the type of one of the plural functions from the network 1, and to send the information related to limitation of the use found by search in the user management unit 7 to the network 1. The network communication unit 8 functions as a search request receiving unit and as a user management information sending unit.

Specifically, the network communication unit 8 receives data for network print, an instruction or setting from the computer 2, and sends the user management information and search result data in response to a search request from the user to the computer 2. The network communication unit 8 is formed by a network interface module and CPU. As an example, in the multi function peripheral apparatus 3, information by function is managed such that, to a user A, network print using the multi function peripheral apparatus 3 is permitted, copying is prohibited, facsimile communication is permitted, and scanning is prohibited.

Also the multi function peripheral apparatus 4 carries out user management by function and has a user management unit 7 and a network communication unit 8 as shown in FIG. 3. The multi function peripheral apparatus 4, too, manages information by function such that, for example, to a user A, network print using the multi function peripheral apparatus 4 is prohibited, copying is permitted, facsimile communication is permitted, and scanning is prohibited.

The machines of FIG. 2 and FIG. 3 also manage information by function for users B to D. In this manner, user management by function is carried out for each machine of the multi function peripheral apparatuses 3 and 4.

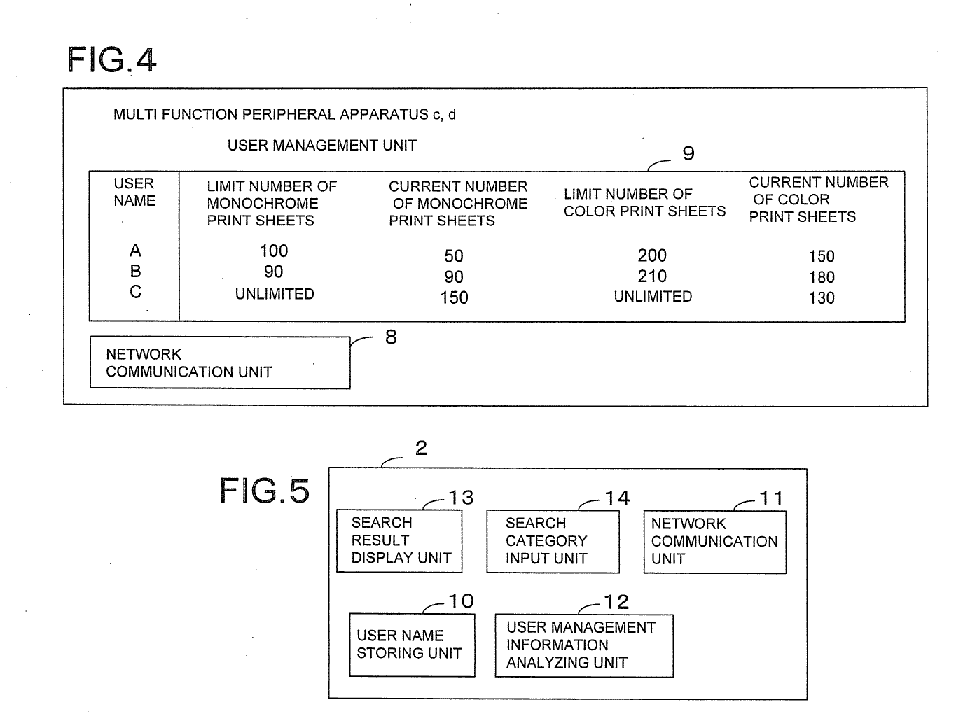

Next, the multi function peripheral apparatus 5 is to carry out user management by color and by the number of print sheets, and has a user management unit 9 and a network communication unit 8 as shown in FIG. 4.

The user management unit 9 holds user management information data and searches for information related to limitation of the use of user management information data corresponding to a user name contained in a search request received by the network communication unit 8. The user management unit 9 functions as a user management information holding unit and as a user management information search unit. The user management information is sent to the computer 2 by the network communication unit 8.

Information related to the limit number of print sheets for the network print function is written in the user management information held by the user management unit 9. The user management unit 9 holds the sum of the numbers of sheets on which network print has been carried out, and monitors whether the number of sheets on which network print has been carried out has reached an upper limit number of print sheets or not, on the basis of the information related to the limit number of print sheets and the sum of the numbers of sheets. That is, the user management unit 9 also functions as a sum holding unit and as a number-of-print-sheets monitoring unit. The functions of the user management unit 9 are realized by a memory device, CPU, ROM and RAM. As a memory device that holds the user management information data, a separate memory device from the user management unit 9 may be used. Alternatively, it may be configured to be removable from the multi function peripheral apparatus 5.

The user management unit 9 also holds user management information data in which information related to the availability of print by color such as color print or monochrome print is written with respect to the network print function. In the case of permitting color or monochrome print, the user management unit 9 also holds data of the limit number of print sheets for each color in the permitted print. Thus, in the multi function peripheral apparatus 5, for example, for a user A, availability information with respect to print by color, which represents the availability of print by color, is managed, and also an upper limit number of sheets that are printable by color is managed.

The user management in the multi function peripheral apparatus 5 will be described further. In the multi function peripheral apparatus 5, for users A to D, the print function can be properly used by color. It carries out management corresponding to the type of print function, for example, only monochrome print is available, only color print is available, or both monochrome print and color print are available. Moreover, the multi function peripheral apparatus 5 limits the number of printable sheets when printing by color for each user. The user management unit 9 manages the number of printable sheets for the print function by color for each user and also manages information such as the total number of printed sheets at the present point for each user.

For example, in the case where the limit number of sheets for monochrome print for the user A is set at 100 in the multi function peripheral apparatus 5, when the multi function peripheral apparatus 5 counts 50 as the current number of monochrome prints, the multi function peripheral apparatus 5 determines that the remaining number of monochrome-printable sheets is 50. In the case where the limit number of sheets for color print for the user A is set at 200 in the multi function peripheral apparatus 5, when the multi function peripheral apparatus 5 counts 150 as the current number of color prints, the multi function peripheral apparatus 5 determines that the remaining number of color-printable sheets is 50. Also, the limit number of sheets for each of color print and monochrome print can be set to be unlimited in the multi function peripheral apparatus 5.

The multi function peripheral apparatus 6 is the same as the multi function peripheral apparatus 5 and carries out user management by color and by the number of print sheets. In this manner, each machine of the multi function peripheral apparatuses 5 and 6 carries out user management by color and by the number of print sheets.

Next, the computers 2 are user terminals. The plural computers 2 connected to the network 1 hold identifier data that can be identified by the multi function peripheral apparatuses 3 to 6. The computer 2 has a user name storing unit 10, a network communication unit 11, a user management information analyzing unit 12, a search result display unit 13, and a search category input unit 14, as shown ion FIG. 5.

The user name storing unit 10 is to store a user name as identifier data of the computer 2 and is formed by a memory device provided in the computer 2.

The network communication unit 11 is to send a search request containing the user name to the respective multi function peripheral apparatuses 3 to 6 and to receive, from the respective multi function peripheral apparatuses 3 to 6, user management information data corresponding to the user name contained in the search request that has been sent. That is, the network communication unit 11 functions as a search request sending unit and as a user management information data receiving unit. The network communication unit 11 is formed by a network interface module provided in the computer 2. Thus, files or data prepared for network print, user management information data, and data for instructions or setting are exchanged with each of the multi function peripheral apparatuses 3 to 6.

The user management information analyzing unit 12 is a multi function peripheral identifier acquiring unit that acquires the identifier of the multi function peripheral apparatus 3 to 6 that has the type of a function available to the computer 2 having the user name, of the multi function peripheral apparatuses 3 to 6, on the basis of the user management information data from the respective multi function peripheral apparatuses 3 to 6 received by the network communication unit 11. Specifically, the user management information analyzing unit 12 acquires the identifier of the multi function peripheral apparatus having the network print function. The user management information analyzing unit 12 is formed by the CPU, ROM and RAM of the computer 2. Thus, the user management information analyzing unit 12 analyzes the user management information data received from the multi function peripheral apparatuses 3 to 6.

The search result display unit 13 is a multi function peripheral apparatus display data generating unit that generates display data for displaying the identifiers of the multi function peripheral apparatuses 3 to 6 acquired by the user management information analyzing unit 12. This search result display unit 13 generates data for displaying information related to limitation of printing such as availability of network print for a user name, availability of one or both of color print and monochrome print, and the upper limit number of printable sheets. The search result display unit 13 also displays this generated display data together with the identifier of the multi function peripheral apparatus acquired by search. The functions of the search result display unit 13 are realized by the CPU, ROM, RAM and a display provided in the computer 2. Thus, the search results for multi function peripheral apparatuses that are available by user or by function, of the multi function peripheral apparatuses 3 to 6, are displayed.

The search category input unit 14 is to input information of search conditions set by a user. For example, a keyboard or mouse is used.

Thus, the searching method for the multi function peripheral apparatus according to the invention is carried out in the following manner in the client server system having the network 1 to which the multi function peripheral apparatuses 3 to 6 are connected, and the computer 2 that communicates with the multi function peripheral apparatuses 3 to 6 via the network 1.

First, the computer 2 sends a search request containing a user name to the respective multi function peripheral apparatuses 3 to 6.

Each of the multi function peripheral apparatuses 3 to 6 extracts information related to limitation of the use of user management information data corresponding to the user name contained in the search request sent from the computer 2, from the memory device that holds user management information data.

Each of the multi function peripheral apparatuses 3 to 6 sends the user management information data containing the extracted information related to limitation of the use, to the computer 2.

The computer 2 receives the user management information data corresponding to the user name, sent from the multi function peripheral apparatuses 3 to 6.

The computer 2 selects a multi function peripheral apparatus having a function available to the computer 2, of the multi function peripheral apparatuses 3 to 6, on the basis of the received user management information data from the multi function peripheral apparatuses 3 to 6.

Each of the multi function peripheral apparatuses 3 to 6 extracts user management information data in which information related to the limit number of print sheets for the network print function is written, from the memory device provided in each of the multi function peripheral apparatuses 3 to 6. The computer 2 acquires the identifier of a multi function peripheral apparatus that has the network print function, of the multi function peripheral apparatuses 3 to 6, thereby selecting the multi function peripheral apparatus. The computer 2 then generates data for displaying information related to limitation of print for network print with respect to the acquired identifier of the multi function peripheral apparatus.

The computer 2 can extract user management information data in which information related to availability of print by color, thereby selecting a multi function peripheral apparatus capable of carrying out network print by color.

The computer 2 can also determine whether the number of network-printed sheets has reached the upper limit number of print sheets in each of the multi function peripheral apparatuses 3 to 6, thereby selecting a multi function peripheral apparatus in which the upper limit number of print sheets has not been reached.

In the computer 2, a search application program for search as the computer program according to the invention is executed. This search application program causes the CPU of the computer 2 to execute the steps of sending a search request containing a user name to each of the multi function peripheral apparatuses 3 to 6, receiving user management information corresponding to the user name contained in the search request from the multi function peripheral apparatuses 3 to 6, acquiring the identifier of a multi function peripheral apparatus having a function available to the computer 2, of the multi function peripheral apparatuses 3 to 6, on the basis of the received user management information data from the multi function peripheral apparatuses 3 to 6, and generating display data for displaying the acquired identifier of the multi function peripheral apparatus.

As the CPU reads out this search application program, the computer 2 is enabled to execute the processing. A memory device that stores the search application program is, for example, a magnetic disk such as a hard disk or flexible disk, an optical disc such as a compact disc, a recording medium such as an IC chip or cassette tape, as well as a ROM or RAM. With such a recording medium, saving, carrying and selling of the search application program can be easily done.

With such a configuration, a series of search processing operations in the server client system according to this embodiment will be described.

The operation of the computer 2 in execution processing of the search application program will now be described.

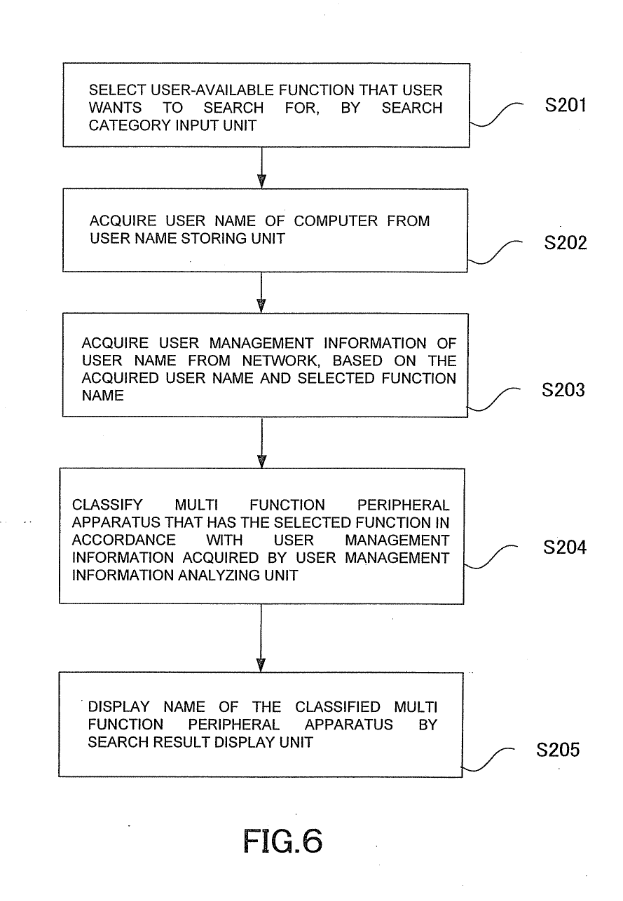

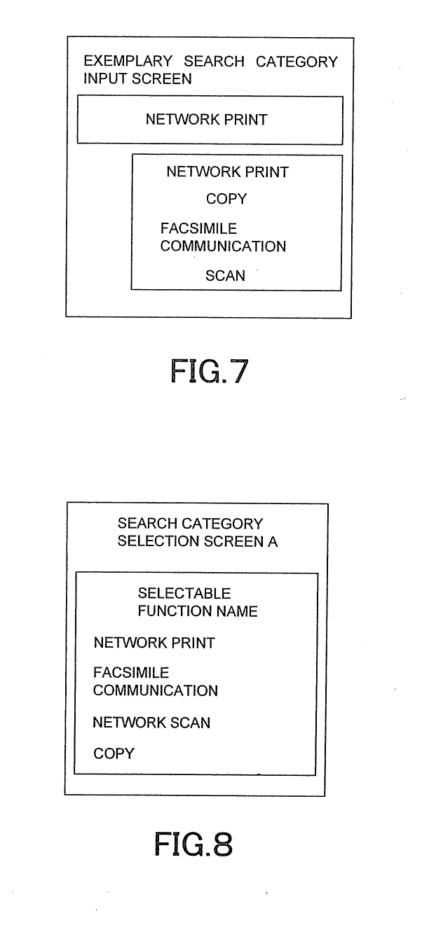

First, in step S201 of FIG. 6, the computer 2 displays a selection screen using a list box shown in FIG. 7. The search category input unit 14 selects network print by using the list box in which plural functions such as network print and copy can be selected. The search category input unit 14 can also select network print by using a screen display, for example, as shown in FIG. 8.

In step S202, the computer 2 acquires the user name of the computer 2 stored in the user name storing unit 10. As an example, in the case where the user name of this computer 2 is “A”, the data of the user A is acquired.

In step S203, the computer 2 provides the acquired data of the user name “A” and the data of network print, which is the selected function, to the network communication unit 11. The network communication unit 11 acquires the user management information of the user name “A” from the network 1 by communicating with each of the multi function peripheral apparatuses 3 to 6. The computer 2 acquires information that the network print function is permitted, as the information of the user A from the multi function peripheral apparatus 3, and also acquires information that the network print function is prohibited, as the information of the user A from the multi function peripheral apparatus 5.

In step S204, the computer 2 analyzes the acquired user management information “A” for the user name “A” by using the user management information analyzing unit 12. The computer 2 classifies the plural machines where network print is permitted, and thus acquires the multi function peripheral apparatus 3.

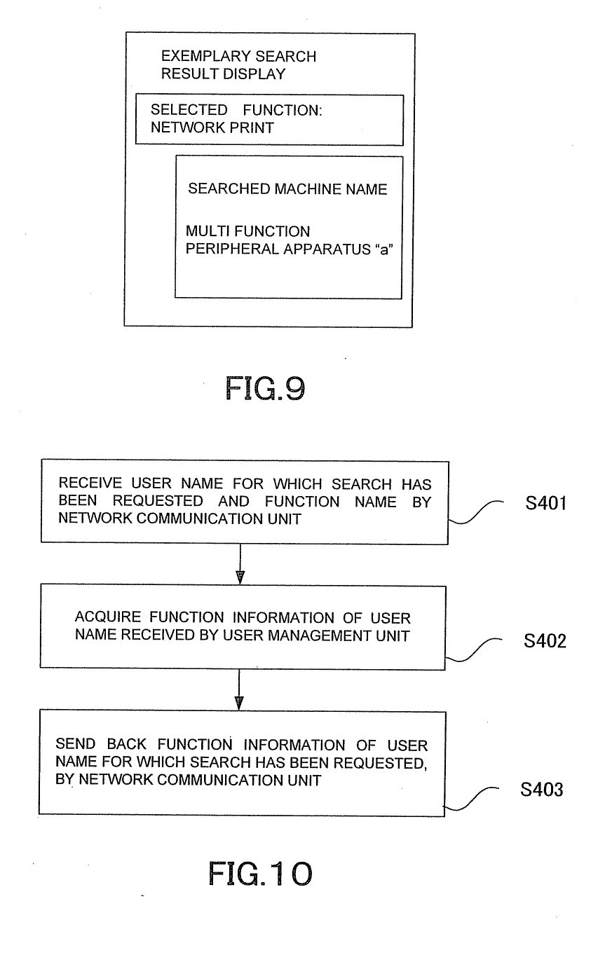

In step S205, the computer 2 displays the name of the multi function peripheral apparatus acquired by the classification, as shown in FIG. 9, by using the search result display unit 13.

In this manner, the multi function peripheral apparatus capable of performing the network print function, of the plural functions, is decided.

Next, each of the multi function peripheral apparatus 3 (shown in FIG. 2) and the multi function peripheral apparatus 4 (shown in FIG. 3) that perform user management by function, carries out processing as shown in FIG. 10 in accordance with an instruction outputted by the search application program of the computer 2.

The multi function peripheral apparatus 3 in step S401 receives the user name “A” for which search has been requested, and the function name “network print”, from the computer 2 by using the network communication unit 8. The multi function peripheral apparatus 3 in step S402 acquires the function information “A” of the user name “A” received from the network 1, by using the user management unit 7. The multi function peripheral apparatus 3 in step S403 sends back the function information of the user name for which search has been requested, to the computer 2 by using the network communication unit 8. Thus, the multi function peripheral apparatus 3 of FIG. 2 acquires the information that the network print function for the user “A” is permitted.

Also in the multi function peripheral apparatus 4, the network communication unit 8 receives the user name “A” for which search has been requested, and the function name “network print”, from the computer 2 (step S401). The user management unit 7 acquires the function information “A” of the user name “A” received from the network 1 (step S402). The network communication unit 8 sends back the function information of the user name for which search has been requested, to the computer 2 (step S403). Thus, the multi function peripheral apparatus 4 of FIG. 3 acquires the information that the network print function for the user “A” is prohibited.

In this manner, each of the multi function peripheral apparatuses 3 and 4 responds to the search request from the computer 2.

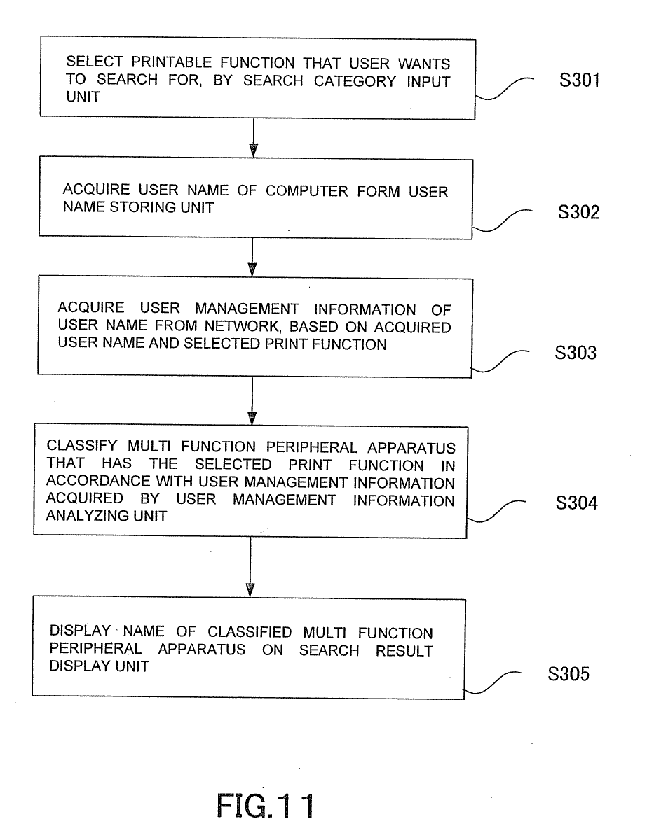

Next, the operation of searching for the multi function peripheral apparatuses 5 and 6 that perform management by the upper limit number of sheets for network print for each user, of the multi function peripheral apparatuses 3 to 6 connected to the network 1, that is, the multi function peripheral apparatus capable of performing network print in which the upper limit number of sheets has not been reached, will be described with reference to FIGS. 11 to 13.

The operation of the computer 2 in the processing of executing the search application program will now be described.

First, the operation of the function of the search application of the computer 2 will be described.

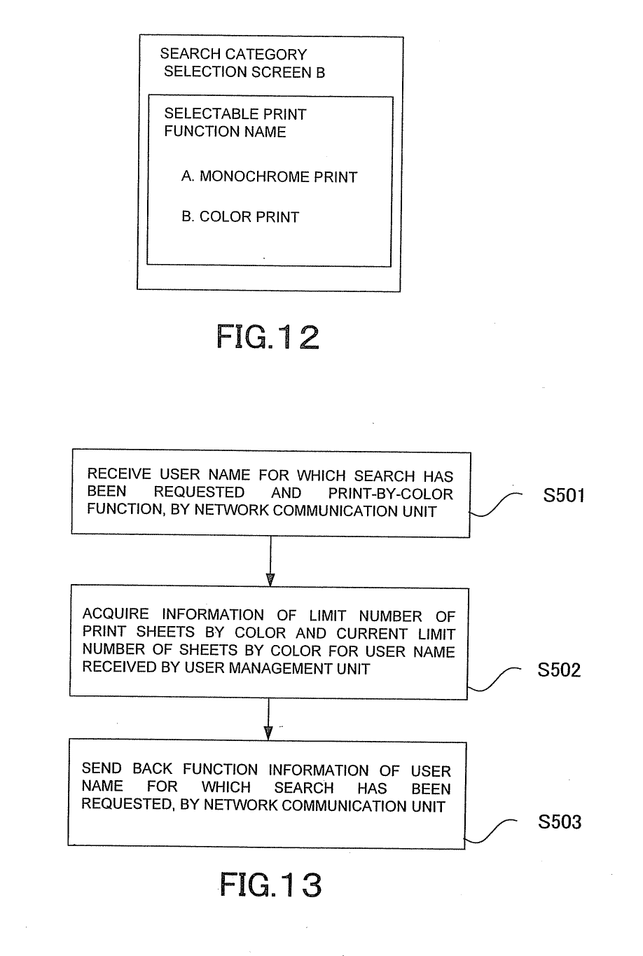

As shown in FIG. 11, in step S301, the computer 2 selects a function or item of printing by color on screen by using the search category input unit 14. The search category input unit 14 selects, for example, color print, of monochrome print and color print on the screen as shown in FIG. 12 in accordance with the search application program that has the function of causing the computer 2 to print by color.

In step 302, the computer 2 acquires the user name of this computer 2 stored in the user name storing unit 10. For example, the user name “A” is selected.

In step S303, the computer 2 provides the acquired user name “A” and the print function “color print” to the network communication unit 11. The network communication unit 11 acquires the user management information of the user name “A” from the network 1. Thus, the computer 2 acquires, for example, information that the network print function is permitted as the information of the user “A” from the multi function peripheral apparatus 3, and also acquires information that the network print function is prohibited as the information of the user “A” from the multi function peripheral apparatus 4.

In step S304, the computer 2 classifies the machine where network print is permitted, of the multi function peripheral apparatuses 3 to 6, with respect to the network print of the user management information “A” acquired by the user management information analyzing unit 12, and thus acquires, for example, “c” indicating the machine of the multi function peripheral apparatus 4.

In step S305, the computer 2 displays the name of the classified multi function peripheral apparatus by using the search result display unit 13.

In this manner, the multi function peripheral apparatus capable of performing network print can be searched for among the plural multi function peripheral apparatuses 3 to 6, and also the multi function peripheral apparatus capable of performing network print by color such as monochrome print or color print can be searched for. Moreover, in this manner, with the search application program according to this embodiment, the user can search for the multi function peripheral apparatus capable of performing network print, by the color as intended for printing.

Next, each of the multi function peripheral apparatuses 5 and 6 that perform user management by function, operates as shown in FIG. 13 in accordance with the processing of executing the search application program in the computer 2.

In step S501, the multi function peripheral apparatus 5 receives the user name “A” for which search has been requested and the function name “network print” from the computer 2 by the network communication unit 8. In step S502, the multi function peripheral apparatus 5 acquires the information of the limit number of color print sheets 200 and the current limit number of color sheets 150 for the user name “A” received by the user management unit 9. In step S503, the multi function peripheral apparatus 5 sends back the function information of the user name for which search has been requested, by using the network communication unit 8.

The processing operation of the multi function peripheral apparatus 6 is the same as the processing operation of the multi function peripheral apparatus 5.

Thus, the multi function peripheral apparatus 5 or the multi function peripheral apparatus 6 capable of performing network print in which the upper limit number of sheets has not been reached, is searched for.

According to the present invention, in a server client system where permission or prohibition of the use of the multi function peripheral apparatuses 3 to 6 is managed by user or by function, a multi function peripheral apparatus available to the user is searched for by function, among the plural multi function peripheral apparatuses 3 to 6 connected to the network 1. Therefore, after searching for one of the multi function peripheral apparatuses, the user does not need to confirm the availability of the desired function with respect to the multi function peripheral apparatus that has been found by search. For example, the user can easily search for a multi function peripheral apparatus in which the network print function is available.

Also, according to the present invention, in a server client system where each user is managed by the upper limit number of sheets for network print, only a multi function peripheral apparatus in which the upper limit number of sheets has not been reached and which is capable of performing network print is searched for from the plural multi function peripheral apparatuses connected to the network 1. Therefore, the search processing can be omitted with respect to the machines of the multi function peripheral apparatuses having functions with limited use.

In the above description, the user management information data is stored in the multi function peripheral apparatuses 3 to 6. However, it may be stored in a device compatible with the multi function peripheral apparatuses 3 to 6. Also, a device incompatible with the multi function peripheral apparatuses, for example, a server computer that manages the management information by function with respect to the user of MFP, may store the user management information. By doing so, the server computer can also realize the above-described search display function.

The user management units 7 and 9 of the multi function peripheral apparatuses 3 to 6 may perform search by using a key indicating each type of plural functions. As user identifiers, data that enables identification of plural users in the network 1 may be used, as well as user names.

The user management information analyzing unit 12 of the computer 2 can acquire the identifier of a multi function peripheral apparatus having one or more of copy, facsimile communication, and scanning, of the plural functions. The search result display unit 13 can generate data for displaying information related to the availability of each function of network print, copy, facsimile communication, and scanning acquired by the user management information analyzing unit 12 with respect to a user identifier.

Although exemplary embodiments of the present invention have been shown and described, it will be apparent to those having ordinary skill in the art that a number of changes, modifications, or alterations to the invention as described herein may be made, none of which depart from the spirit of the present invention. All such changes, modifications, and alterations should therefore be seen as within the scope of the present invention.

What is claimed is:

1. A multi function peripheral apparatus having a plurality of functions, comprising:
a search request receiving unit configured to receive from a network a user identifier and a search request containing type of one function of the plurality of functions;
a user management information holding unit configured to hold user management information data in which information related to limitation of use by each user is written for each type of the plurality of functions;
a user management information search unit configured to search for the information related to limitation of use of the user management information data corresponding to the user identifier contained in the search request received by the search request receiving unit, from the user management information holding unit; and
a user management information sending unit configured to send to the network the information related to limitation of use found by search by the user management information search unit.

2. The multi function peripheral apparatus of claim 1, wherein the user management information holding unit holds the user management information data in which information related to a limit number of print sheets is written with respect to a network print function of the plurality of functions.

3. The multi function peripheral apparatus of claim 2, wherein the apparatus comprises:
a sum holding unit configured to hold the sum of the number of sheets on which network print has been done; and
a number-of-print-sheets monitoring unit configured to monitor whether the number of sheets on which network print has been done has reached an upper limit number of print sheets or not, on the basis of the information related to the limit number of print sheets held by the user management information holding unit and the sum held by the sum holding unit.

4. The multi function peripheral apparatus of claim 1, wherein function of network print, copy, facsimile communication, and scanning are provided as the plurality of functions.

5. The multi function peripheral apparatus of claim 1, wherein the user management information holding unit holds the user management information data in which information related to availability of print by color is written with respect to the network print function.

6. A user terminal in a system in which a plurality of multi function peripheral apparatus having a plurality of functions is connected via a network, the user terminal comprising:
a search request sending unit configured to send a search request containing a user identifier to each multi function peripheral apparatus;
a user management information data receiving unit configured to receive, from each multi function peripheral apparatus, user management information in which information related to limitation of use is written for each type of the plurality of functions, the user management information corresponding to the user identifier contained in the search request sent from the search request sending unit;
a multi function peripheral identifier acquiring unit configured to acquire an identifier of a multi function peripheral apparatus having type of one function available to a terminal having the user identifier, of the plurality of multi function peripheral apparatuses, on the basis of the user management information data from each multi function peripheral apparatus received by the user management information data receiving unit; and
a multi function peripheral apparatus display data generating unit configured to generate display data for displaying the identifier of the multi function peripheral apparatus acquired by the multi function peripheral apparatus identifier acquiring unit.

7. The user terminal of claim 6, wherein the multi function peripheral apparatus identifier acquiring unit acquires an identifier of a multi function peripheral apparatus having a network print function, of the plurality of functions.

8. The user terminal of claim 7, wherein the multi function peripheral apparatus display data generating unit generates data for displaying information related to limitation of printing of network print with respect to the user identifier.

9. The user terminal of claim 7, wherein the multi function peripheral apparatus identifier acquiring unit acquires an identifier of a multi function peripheral apparatus having one or more functions of copy, facsimile communication, and scanning, of the plurality of functions, and
the multi function peripheral apparatus display data generating unit generates data for displaying information related to availability of each function of network print, copy, facsimile communication, and scanning acquired by the multi function peripheral apparatus identifier acquiring unit with respect to the user identifier.

10. A system including a network to which a plurality of multi function peripheral apparatuses having a plurality of functions is connected, and a user terminal communicating to each of the multi function peripheral apparatuses via the network, the system comprising:
a search request receiving unit configured to receive from the network a search request containing a first user identifier and type of one function of the plurality of functions;
a user management information holding unit configured to hold user management information data in which information related to limitation of use by each user is written for each type of the plurality of functions;
a user management information search unit configured to search for the information related to limitation of use of the user management information data corresponding to the first user identifier contained in the search request received by the search request receiving unit, from the user management information holding unit; and
a user management information sending unit configured to send to the network the user management information data including the information related to limitation of use found by search by the user management information search unit;
wherein the user terminal comprises:
a search request sending unit configured to send a search request containing a second user identifier to each multi function peripheral apparatus;
a user management information data receiving unit configured to receive the user management information data corresponding to the second user identifier sent from the user management information sending unit of each multi function peripheral apparatus;
a multi function peripheral apparatus identifier acquiring unit configured to acquire an identifier of a multi function peripheral apparatus having type of one function available to the user terminal, of the plurality of multi function peripheral apparatuses, on the basis of the user management information data from each multi function peripheral apparatus received by the user management information data receiving unit; and
a multi function peripheral apparatus display data generating unit configured to generate display data for displaying the identifier of the multi function peripheral apparatus acquired by the multi function peripheral apparatus identifier acquiring unit.

11. A method of searching for a multi function peripheral apparatus having a plurality of functions, in a system including a network to which a plurality of the multi function peripheral apparatuses are connected, and a user terminal communicating to each of the multi function peripheral apparatus via the network, the method comprising the steps of:
the user terminal sending a search request containing a user identifier to each multi function peripheral apparatus;
each multi function peripheral apparatus extracting, from a memory device holding user management information data in which information related to limitation of use by each user is written for each type of the plurality of functions, the information related to limitation of use of the user management information data corresponding to the user identifier contained in the search request sent from the user terminal;
each multi function peripheral apparatus sending the user management information data including the extracted information related to limitation of use to the user terminal;
the user terminal receiving the user management information data corresponding to the user identifier sent from each multi function peripheral apparatus; and
the user terminal selecting a multi function peripheral apparatus having any function available to the user terminal, of the plurality of multi function peripheral apparatuses, on the basis of the received user management information data from each multi function peripheral apparatus.

12. The searching method for the multi function peripheral apparatus of claim 11, wherein in the extraction at each multi function peripheral apparatus, the user management information data in which information related to a limit number of print sheets is written with respect to a network print function of the plurality of functions is extracted from the memory device, and
in the selection of the multi function peripheral apparatus at the user terminal, the user terminal acquires an identifier of a multi function peripheral apparatus having the network print function of the plurality of multi function peripheral apparatuses, and generates data for displaying information related to limitation of printing for network print with respect to the acquired identifier of the multi function peripheral apparatus.

13. The searching method for the multi function peripheral apparatus of claim 11, wherein in the extraction at each multi function peripheral apparatus, the user management information data in which information related to availability of print by color is written with respect to a network print function of the plurality of multi function peripheral apparatuses is extracted from the memory device, and
in the selection of the multi function peripheral apparatus at the user terminal, the user terminal acquires an identifier of a multi function peripheral apparatus having a network print function by color of the plurality of multi function peripheral apparatuses, and generates data for displaying information related to limitation of printing for network print with respect to the acquired identifier of the multi function peripheral apparatus.

14. The searching method for the multi function peripheral apparatus of claim 11, wherein in the extraction at each multi function peripheral apparatus, the user management information data containing a determination result about whether the number of network-printed sheets reaches an upper limit number of print sheets with respect to the plurality of multi function peripheral apparatuses is extracted from the memory device, and
in the selection of the multi function peripheral apparatus at the user terminal, the user terminal acquires an identifier of a multi function peripheral apparatus in which the number of network-printed sheets has not reached the upper limit number of print sheets, of the plurality of multi function peripheral apparatuses, and generates data for displaying information related to limitation of printing for network print with respect to the acquired identifier of the multi function peripheral apparatus.

15. A computer program for causing a computer, which is to be used for a user terminal in a system in which a plurality of multi function peripheral apparatuses having a plurality of functions is connected via a network, to execute the steps of:
sending a search request containing a user identifier to each multi function peripheral apparatus;
receiving, from each multi function peripheral apparatus, user management information in which information related to limitation of use is written for each type of the plurality of functions corresponding to the user identifier contained in the search request;
acquiring an identifier of a multi function peripheral apparatus having one function available to the user terminal, of the plurality of multi function peripheral apparatuses, on the basis of the received user management information data from each multi function peripheral apparatus; and
generating display data for displaying the acquired identifier of the multi function peripheral apparatus.
